(19) United States
(12) Patent Application Publication
(10) Pub. No.: US 2019/0258375 A1
(43) Pub. Date: Aug. 22, 2019

(54) METHODS AND SYSTEMS FOR RESIDENT CONTROL OF DEVICES USING HTML AND JAVASCRIPT

(71) Applicant: BOSE CORPORATION, Framingham, MA (US)

(72) Inventors: Jonathan Cooper, Newport, RI (US); Trevor Irving Lai, Wayland, MA (US); Marc Gudell, Milford, MA (US); Santosh Gondi, Lexington, MA (US); Stephen Tindall, Jefferson, MA (US)

(21) Appl. No.: 15/901,579

(22) Filed: Feb. 21, 2018

(51) Int. Cl. G06F 3/0488; G06F 3/044; G06F 9/451; G06F 17/30

(52) U.S. Cl. CPC G06F 3/0488; G06F 17/30896; G06F 9/451; G06F 3/044

(57) ABSTRACT

A device includes an input/output element; a device controller configured to detect a user input event; an embedded web browser; and a state controller executing as an interpreted language application on the embedded web browser, the state controller configured to receive an indication of the user input event; determine an updated state of the input/output element responsive to the user input event; change a state of the input/output element to the updated state; and cause the input/output element to be updated according to the updated state.

### BACKGROUND

### Technical Field

The application relates generally to controlling the state of a display of a device, and more particularly, in one example, to changing a state of a user interface based on system events.

### Background

Devices with user interfaces accept input from users, and may take appropriate action in response. User interfaces may include touch-based interfaces, such as buttons, keys, and capacitive sensors. Other user interfaces include microphones, optical sensors, and other components capable of receiving input. Users interact with user interfaces to make the device take some action, such as playing music or videos, changing the volume of music being played, or the like.

In addition to performing the action requested by the user, devices often provide feedback, via the user interface, that the user input has been received. Where possible, the feedback may be specific to the requested action. For example, pushing a key on the device to mute playback of music may cause the device to play an audible tone, reassuring the user that the input has been received and the intended action has been taken. Similarly, sliding a finger along a capacitive strip, or pushing a button, in order to change a playback volume may cause the device to visually display an indication of the current volume on the user interface, such as by lighting up an area of the capacitive sensor proportional to the current volume. The indication confirms for the user that the volume is being changed, and also helps the user to more precisely adjust the volume.

Currently available devices control the appearance of user interface elements through embedded code, often written in a coding language such as C++ and then compiled, to be installed onto the device prior to booting up. For example, a light display animation, such as in the volume-adjusting example above, would be part of the compiled firmware of the device, and may be written at the hardware level for a particular interface of a particular device. Developers therefore often must create and debug customized display state controllers for each type of device being developed. Should it be necessary or desirable to modify the animation, or to use a different animation, the firmware would have to be modified, recompiled, and reloaded onto the device, which would then have to be rebooted for the change to take effect. Rebooting a device is a relatively time-consuming process during which the device is non-operational.

### SUMMARY

The examples described and claimed here overcome the drawbacks of currently available devices by employing a state controller operating as an interpreted language application. In particular, the state controller may be implemented as a combination of hypertext markup language HTML5 and Javascript, the combination referred to here as HTML5/JS. The HTML5/JS state controller provides a number of advantages over currently available devices. First, the application is not part of the embedded code of the device, and executes without needing to be compiled. This allows for “hot swapping” of the state controller during operation of the device, permitting changes to be made to the state controller (e.g., changes to an animation associated with a user input) without requiring a reboot of the device. Iterative changes to the state controller can be made and tested during the development and prototyping of the device without requiring a reboot each time, thereby shortening development time. Second, the HTML/JS state controller allows for abstraction of the details of the rendering of display elements (e.g., text), which is handled by the HTML model itself. This allows developers of a user interface to focus on its particular appearance and behavior, rather than machine-specific considerations such as font spacing, kerning, and the like.

According to one aspect, a device includes an input/output element; a device controller configured to detect a user input event; an embedded web browser; and a state controller executing as an interpreted language application on the embedded web browser, the state controller configured to receive an indication of the user input event; determine an updated state of the input/output element responsive to the user input event; change a state of the input/output element to the updated state; and cause the input/output element to be updated according to the updated state.

According to one example, the interpreted language application is implemented in HTML5 and javascript.

According to another example, the interpreted language application is configured to operate with reference to a first non-compiled file, and the state controller is further configured to receive a second non-compiled file and operate the interpreted language application with reference to the second non-compiled file. According to a further example, the first non-compiled file is hot swapped with the second non-compiled file during operation of the device. According to yet another example, at least one of the first non-compiled file and the second-non-compiled file associates the user input event with an intended action and the updated state.

According to another example, the user input event is detected at a user interface at least partially overlapping with the input/output element. According to still another example, the updated state of the input/output element is provided to the device controller. According to another example, the state controller is configured to change the state of the input/output element to the updated state by writing a web frame to be rendered on the input/output element.

According to yet another example, the state controller is further configured to request, from the device controller, content for the updated state. According to a further example, the input/output element is a lightbar, and the content is at least one lightbar pattern.

According to one example, the state controller is communicatively coupled to the device controller by at least one websocket. According to another example, the input/output element comprises at least one of a button, a key, a touch region, a capacitive region, a lightbar, and a display.

According to another aspect, a method of operating a device having a input/output element is provided. The method includes detecting a user input event; receiving, by a state controller executing as an interpreted language application on an embedded web browser of the device, an indication of the user input event; determining, by the state controller, an updated state of the input/output element responsive to the user input event; changing, by the state controller, a state of the input/output element to the updated state; and causing the input/output element to be updated according to the updated state.

According to one example, the interpreted language application is configured to operate with reference to a first non-compiled file, and the method includes receiving a second non-compiled file and operating the interpreted language application with reference to the second non-compiled file. According to a further example, the method includes hot swapping the first non-compiled file with the second non-compiled file during operation of the device. According to a still further example, at least one of the first non-compiled file and the second-non-compiled file associates the user input event with an intended action and the updated state.

According to one example, the method includes providing, by the state controller, the updated state of the input/output element to the device controller. According to another example, changing the state of the input/output element to the updated state includes writing a web frame to be rendered on the input/output element.

According to another example, the method includes requesting, by the state controller, content for the updated state from the device controller. According to a further example, the input/output element is a lightbar, and the content is at least one lightbar pattern.

According to another example, the user input event is detected at a user interface comprising a capacitive region, and receiving the indication of the user input event includes receiving coordinates of a location on the capacitive region contacted by a user, and wherein determining the updated state of the input/output element responsive to the user input comprises determining, from the coordinate of the location on the capacitive region contacted by the user, a predefined input value.

According to another example, the user input event is one of a key hover, a key press, a key press and release, a key press and hold, and a repeated key press and hold. According to yet another example, the input/output element comprises at least one of a button, a key, a touch region, a capacitive region, a lightbar, and a display.

In the examples described here, the state and operation of the device itself may be controlled by embedded systems, with the exception that the state of the user interface (e.g., its appearance or functionality) is controlled by the interpreted language application in response to receiving user input. In these examples, the state controller may be notified by the embedded system that the music playback volume has been changed, with the state controller being responsible for changing a lightbar animation in response. It will be appreciated, however, that in other examples the state of other aspects of the device, or even the entire device itself, may be controlled by one or more interpreted language applications. For example, the processing of user input and the performance of the action intended by the user input may also be handled by a HTML5/JS application, thereby avoiding the need for embedded code for such operations. In one use case example, the state controller itself may determine how the volume should be changed based on the user input, and cause the system controller to make the necessary adjustment.

### BRIEF DESCRIPTION OF DRAWINGS

Various examples are discussed below with reference to the accompanying figures, which are not intended to be drawn to scale. The figures are included to provide an illustration and a further understanding of the various aspects, and are incorporated in and constitute a part of this specification, but are not intended as a definition of the limits of any claim or description. The drawings, together with the remainder of the specification, serve to explain principles and operations of the described and claimed aspects and examples. In the figures, each identical or nearly identical component that is illustrated in various figures is represented by a like numeral. For purposes of clarity, not every component may be labeled in every figure. In the figures:

FIG. 1A illustrates a device according to an example;

FIG. 1B illustrates a device according to an example;

FIG. 2 is a block diagram of a system according to an example; and

FIG. 3 is a flow chart of a method for using a device or system according to an example.

### DESCRIPTION

The examples described and claimed here overcome the drawbacks of currently existing state controllers. In particular, the state controller for display and UI elements in the exemplary devices are implemented as interpreted language applications, such as HTML5/JS, rather than a compiled language such as C++. By implementing the state controller in HTML5/JS, changes to the state logic can be “hot-swapped” during operation of the device, without requiring a reboot. Implementing the state controller in an interpreted language also avoids the need to create executable files for different architectures/devices.

The ability to hot swap interface behaviors is also advantageous to the user experience, allowing updated or changed behaviors to be employed without disruption to, or even detection by, the end user of the device. In one exemplary use case, a HTML5/JS state controller may be used to dynamically modify or limit the behavior of the user interface during a demonstration mode, such as in a retail environment. Delivering a user interface presentation tailored to this environment can ensure a more controlled, positive shopping experience. In another exemplary use case, the HTML5/JS state controller may selectively modify the display of the user interface when the device (e.g., a speaker) becomes part of a group of synchronized devices used for multiroom or group playback. In such situations, if the device is a “slave” in the group, its user interface may take on an appearance reflecting this role, and/or indicating that the device is not able to presently accept user input. Using an interpreted language state controller to dynamically change the appearance and presentation of input/output elements during operation of the device simplifies the process of writing application code for the device.

In some examples, the device described is a media playback device, such as a “smart speaker.” The device receives user input through a user interface, and plays music, videos, or other media via one or more speakers and a display. The user interface may include input elements such as buttons, keys, capacitive touch sensors or regions, and light emitting diode (LED) lights, the latter in some cases arranged in a line to form a lightbar. The device may also include one or more display screens, such as a liquid crystal display (LCD). To process input and system events, one or more processors are included. The state controller and a product controller may be provided on a system-on-a-chip (SoC). An embedded system is also provided. The embedded system detects system events, such as user input, and may take some appropriate action. For example, the embedded system may detect that a user has pressed a particular button for a particular duration during a particular state of the device, such as during playback of music. The embedded system may notify the SoC of the button press, or may make some determination regarding the action intended by the user input and notify the SoC.

The product controller receives the notification regarding the button press and/or the intended action. For example, the embedded system may send a message to the product controller that the volume button has been pressed, or that the embedded system has changed (or is about to change) the volume. In response to this notification, the state controller determines an updated state for one or more interface elements, such as a lightbar, LED, or capacitive sensor. For example, the state controller may determine that a particular animation is to be displayed on the lightbar for the updated state, and that a particular message (e.g., “VOL UP”) is to be displayed on a LCD screen. The state controller instructs the product controller to play a particular presentation on the user interface, and may cause “VOL UP” to be displayed on the LCD. The product controller may in turn communicate the presentation information to the embedded system. The embedded system then obtains specific display and timing information about the presentation from a data store, and causes the presentation to be played on the lightbar.

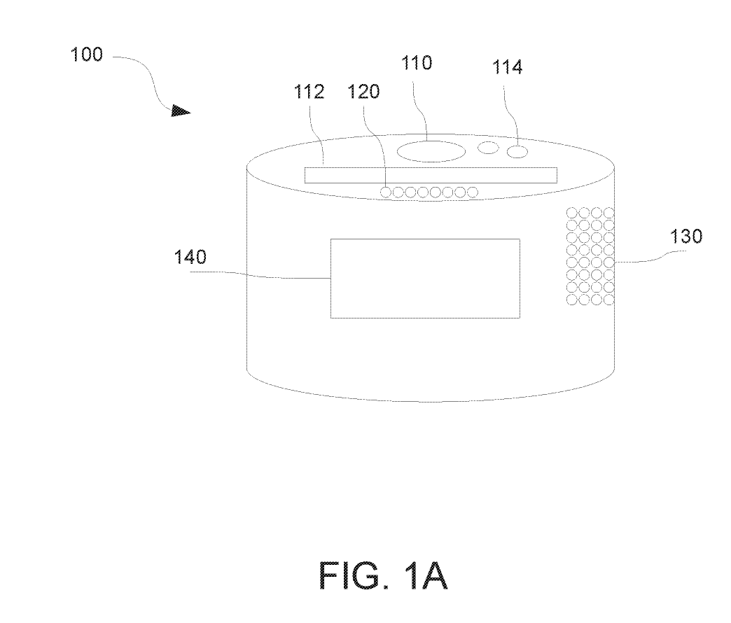

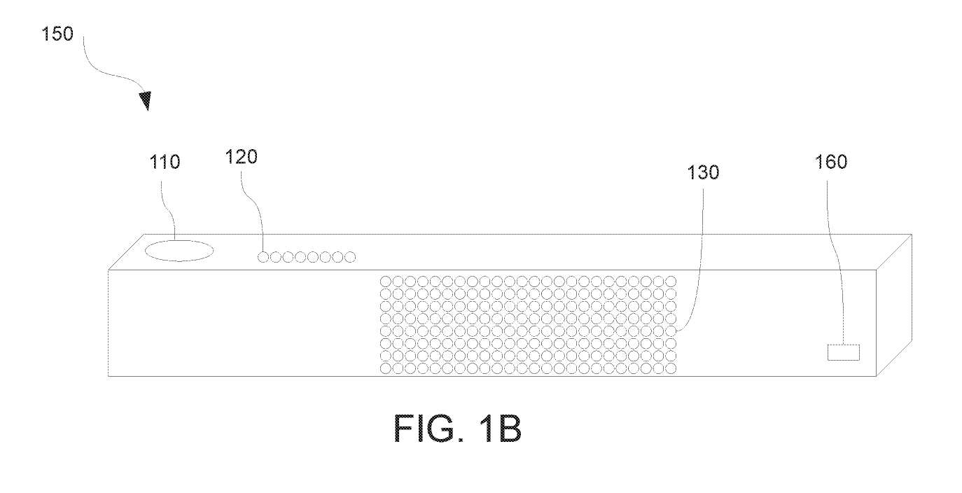

Exemplary devices 100 and 150 employing an interpreted language (e.g., HTML5/JS) state processor are shown in FIGS. 1A and 1B, respectively. The devices 100, 150 include a user interface having one or more input elements, such as buttons 110. The user interface may further include a display element, such as a lightbar 120 employing LEDs or other elements for providing a visual indicator to a user of the device. The user interface may further include an electro-acoustic transducer 130 capable of playing media and communicating with the user. In some examples, the device 100 may include other user interface elements, such as a capacitive sensor 112, one or more LEDs 114, and may include a display 140 for display LCD or graphical information. Devices in other examples, such as device 150, may not include a display 140 in the device 150 itself. Rather, the device may instead (or additionally) provide the ability to transmit media to other devices, such as a television or computer display (not shown). For example, device 150 may include a port 160 for transmitting HDMI, VGA, or other video signals to a separate display device.

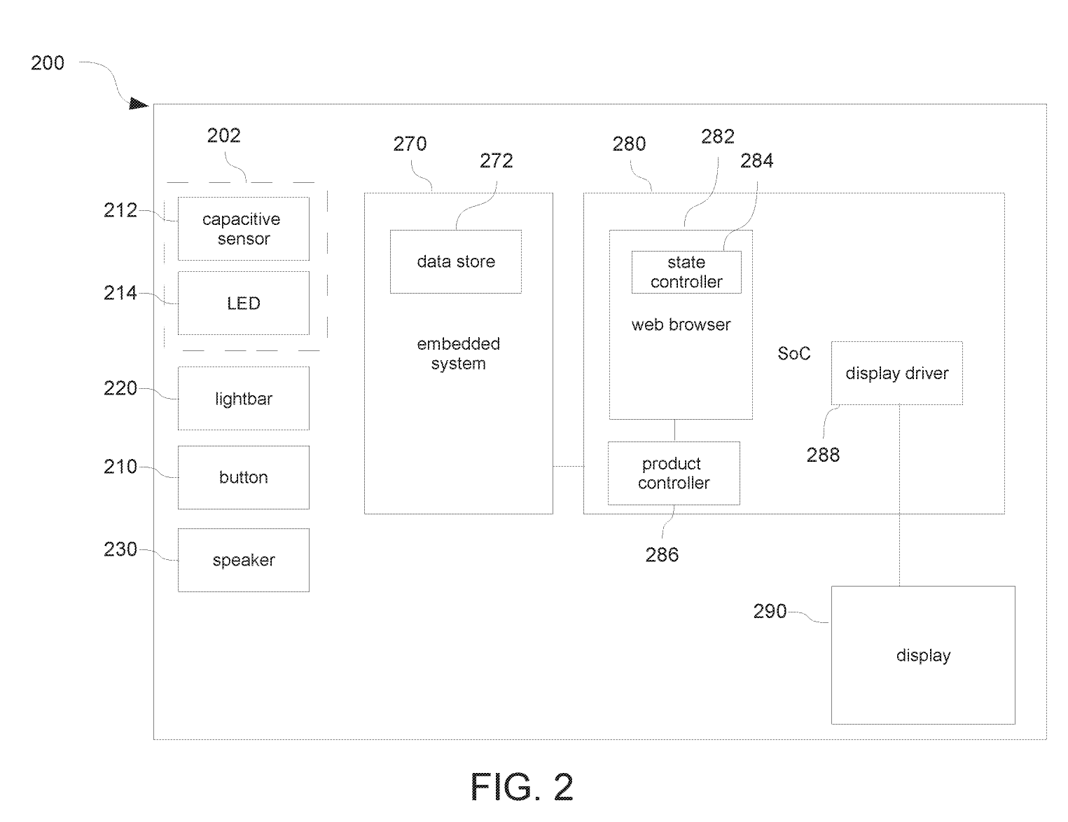

A block diagram of some of the operational components of such a device 200 is shown in FIG. 2. The device 200 includes an embedded system 270 and a system-on-a-chip (SoC) 280.

The embedded system 270 handles many system-related events, including detecting the input/output from user interface elements 210-220, as well as driving the at least one electro-acoustic transducer 230. Upon detecting user input at a user interface element 210-220, the embedded system 270 may take some action that changes a state of the device 200, and may notify the SoC 280 of the user input and/or the device state change. In response, and as described in more detail below, the SoC 280 may determine that an element 210-220 of the user interface should change its state, and instructs the embedded system 270 to change the state of the element, such as by displaying an animation or other presentation on the user interface element.

The user interface elements 210-220 may include one or more buttons 210, capacitive sensors 212, LEDs 214, and lightbars 220. Some of the user interface elements 210-220 may be solely for input (such as, in some examples, a physical button 210), whereas some may be solely for output (such as, in some examples, a LED 214). Some user interface elements 210-220 may have both input and output capabilities, or may be combined to provide such functionality. For example, a capacitive sensor 212 may be overlaid or underlaid with one or more LEDs 214. As the user interacts with the capacitive sensor 212, the one or more LEDs 214 may react accordingly, such as by “following” the user's finger by lighting up a region underneath the user's finger. Such elements, or combinations of elements, may be collectively referred to as input/output elements 202.

The embedded system 270 is implemented on a microcontroller. It may include or consist of firmware or other compiled executable software written in C++ or other compiled language. The embedded system 270 communicates with other components of the device 100. The embedded system 270 may further include a data store 272. The data store 272 may store information about one or more presentation programs that can be implemented on the user interface. Each presentation programs may include information necessary for the embedded system 270 to perform the presentation. For example, the presentation program may identify which of the user interface elements 210-220 and/or input/output elements 202 are involved in the presentation; timing and color information for activating/deactiving those elements during the presentation; and information for any other aspects of the presentation to be performed by the embedded system 270, such as any audio information to be played (music, chimes, tones, etc.) during the presentation.

The SoC 280 includes an embedded web browser 282 in which a state controller 284 executes. The state controller 284 determines the state of one or more of the user interface elements 210-220, and is implemented as an interpreted language application, for example, in HTML5/JS. The embedded web browser 282 can be used to control a display driver 288, which in turn drives a display 290, such as an LCD display. In this manner, the state controller 284 can cause graphics and/or text to appear on the display 290, such as in response to the state of a user interface element 210-220 changing.

The SoC 280 further includes a product controller 286 configured to communicate with the embedded system 270, the embedded web browser 282, the state controller 284, and other components of the device 200. For example, the state controller 284 is configured to receive, via the product controller 286, a message from the embedded system 270 indicating that a state of the device 200 has changed. In response, the state controller 284 determines an updated state of one or more elements of the user interface of the device 200. For example, the state controller 284 may determine, responsive to a user tapping on the button 210 during playback of music, that a particular presentation (e.g., an animation of LED lights in a lightbar) should be played. The state controller 284 may make this determination with reference to a data store 281 that associates a particular state of the device with a particular presentation to be implemented on one or more interface elements.

After determining the updated state, the state controller 284 sends to the product controller 286 a request that the state of the one or more elements of the user interface 200 be modified accordingly. The state controller 284 is not configured to control the specifics of what is presented at the user interface 200 as a result of the changed state, but may rather send the product controller 286 a request that a particular presentation associated with the current state of the user interface be performed. Continuing the earlier example, the state controller 284 may be configured to determine that an arbitrary presentation stored on the device 200 (e.g., presentation #11 of 22) be displayed in response to the user tapping on the button 210. The state controller 284 communicates an identifier of the presentation to the product controller 286, which in turn passes the identifier to the embedded system 270.

The embedded system 270 retrieves the presentation from the data store 272. The embedded system 270 then proceeds to execute the presentation according to this information. The appearance of one or more user interface elements is modified according to the presentation. The presentation may be performed on a user interface element other the element at which input was detected. For example, if user input is detected at button 210, an animation may be displayed at lightbar 220. Alternatively, the presentation may be performed at the same input/output element 202 at which the user input was detected. For example, if user input is detected at the capacitive sensor 212 of the input/output element 202, the presentation may be performed on one or more LEDs 214 of the input/output element 202. If the capacitive sensor 212 overlays the LEDs 214, the presentation may light up the LEDs 214 in response to the location of the user's finger on the capacitive sensor 212.

The state controller 284, being implemented as an interpreted language application, can be readily modified during development or use of the device 200 without interruption to the operation of the device. For example, if it is determined that the presentation that is executed in response to a particular user input should be changed, the state controller 284 can be modified to select a different presentation in response to the user input during operation of the device with requiring that the device be rebooted.

The state controller 284 may be configured to communicate with other components of the device 200 in addition to the product controller 286. The state controller 284 may be configured to communicate with a network interface (not shown) of the SoC 280, such as via a web socket. For example, the state controller 284 may determine, in response to an indication that the device 200 is playing a particular song, that the album art associated with the song should be displayed on the display 290. The state controller 284 may therefore be configured to access a database on an external system, for example, on a cloud-based system, in order to download a graphic of the album art and display the artwork on the display 290. In another example, the state controller 284 may determine that an Internet video should be displayed to an external device connected the device 200 by an HDMI port (e.g., port 160). The embedded web browser 282 and/or the state controller 284 may access the video via a web socket connection and stream the video for display to the HDMI port.

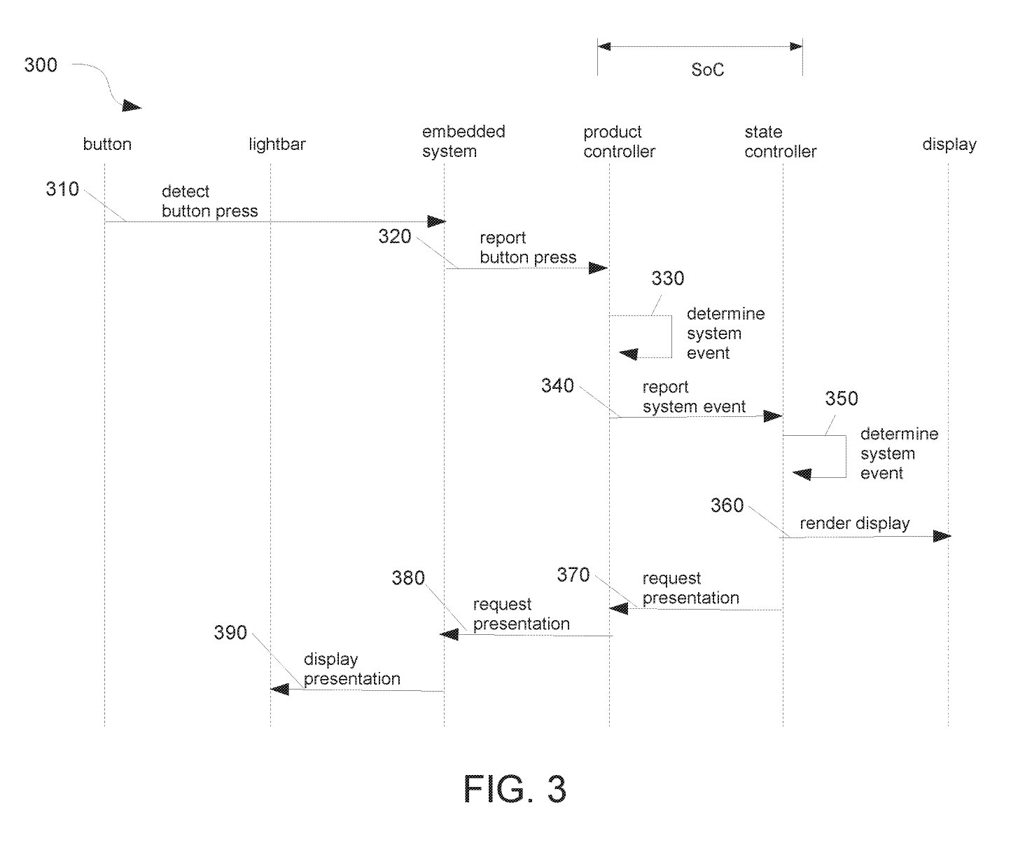

Interactions between components of a device (e.g., device 200 of FIG. 2) in an exemplary use case 300 are shown in FIG. 3. In this example, user input is received at an input/output element (e.g., element 202) of the device. An embedded system (e.g., embedded system 270) notifies a state controller of the device (e.g., state controller 284) of the input, the state controller operating in an embedded browser (e.g., embedded web browser 282) executing on a system-on-a-chip (SoC 280). In response, the state controller directs the embedded system to display a particular presentation on the input/output element. The embedded browser also writes output to a display device (e.g., display 290).

At step 310, the embedded system detects that a user interface element (e.g., a button) was pressed. The user interface element may be part of an input/output element as discussed above, and may be integral with the device itself, may be located on a remote control or other peripheral of the device, or located on a separate device. Information about the button press may be detected by the embedded system. For example, the duration and number of times that the button was pressed and/or released and the operating context of the device at the time of the input may be tracked by the embedded system. Additional specific information may also be determined based on the type of input/output element. For example, where the input/output element is a capacitive strip sensor, the coordinates of the current location of the user's finger may be tracked as the user performs a swipe across the strip. These coordinates may be provided to the embedded system, the product controller, and/or the state controller to identify, based on the location of the input, the system event and the resulting change to the state of the user interface.

At step 320, the embedded system reports the input event, and any information about the event, to a product controller (e.g., product controller 286) operating on the SoC.

At step 330, the product controller, with reference to the input event and any related information, determines that the embedded system has taken action in response to the input event. For example, the product controller may determine, based on the fact that the user pressed a button to reduce the volume of music during playback, that the embedded system has in fact reduced the playback volume. In another example, the product controller may merely be notified that the “reduce volume” button was pushed, and may be responsible for making the determination that the playback volume should be changed and informing the embedded system accordingly.

At step 340, the product controller sends a message to the state controller that a system event has occurred. Continuing the example, the product controller informs the state controller that the playback volume has been reduced to 70%.

At step 350, the state controller determines that a change that should be made to the user interface appearance, animation, or other presentation in response to the system event. For example, the state controller may determine that an animation should be played on a lightbar under a capacitive sensor indicating that the volume is now at 70%. The state controller may make this determination with reference to stored logic or other information relating system events to interface presentations that should be performed when the system event has occurred. In some examples, a mapping of system events to presentation identifiers may be stored in a data store (e.g., data store 287). The state controller need not store or access the specific information for executing the presentation, such as timing or hardware-specific information. Rather, the presentation identifier need only identify a presentation stored and accessible (e.g., in data store 272) by the embedded system.

By implementing the state controller as an interpreted language application, the presentation to be displayed in response to a particular system event can be changed dynamically by developers, or based on system context (e.g., when the device is in a demonstration mode). In one example, different system event-presentation associations may be provided in different files that are selectively accessed by the device according to an operating mode of the device. In another example, new system event-presentation associations may be provided to the device during operation, with these new associations controlling the presentation of events going forward without requiring a reboot of the device first.

At step 360, the state controller causes a display to be rendered on the display. For example, the state controller may cause the embedded web browser on which it is executing to write output in a web format (e.g., HTML5) to a display driver, which in turn writes the output to a display. For example, if the display is an LCD on the device, the state controller may cause the display to temporarily read “VOL 70%.”

At step 370, the state controller instructs the product controller to request the pattern or presentation associated with the presentation identifier, and at step 380, the request is passed to the embedded system.

At step 390, the embedded system accesses the presentation associated with the presentation identifier, and displays the presentation/pattern on the lightbar of the device.

As discussed above, aspects and functions disclosed herein may be implemented as hardware or software on one or more of these computer systems. There are many examples of computer systems that are currently in use. These examples include, among others, network appliances, personal computers, workstations, mainframes, networked clients, servers, media servers, application servers, database servers and web servers. Other examples of computer systems may include mobile computing devices, such as cellular phones and personal digital assistants, and network equipment, such as load balancers, routers and switches. Further, aspects may be located on a single computer system or may be distributed among a plurality of computer systems connected to one or more communications networks.

For example, various aspects and functions may be distributed among one or more computer systems configured to provide a service to one or more client computers. Additionally, aspects may be performed on a client-server or multi-tier system that includes components distributed among one or more server systems that perform various functions. Consequently, examples are not limited to executing on any particular system or group of systems. Further, aspects may be implemented in software, hardware or firmware, or any combination thereof. Thus, aspects may be implemented within methods, acts, systems, system elements and components using a variety of hardware and software configurations, and examples are not limited to any particular distributed architecture, network, or communication protocol.

The computer devices described herein are interconnected by, and may exchange data through, a communication network. The network may include any communication network through which computer systems may exchange data. To exchange data using the network, the computer systems and the network may use various methods, protocols and standards, including, among others, Fibre Channel, Token Ring, Ethernet, Wireless Ethernet, Bluetooth, Bluetooth Low Energy (BLE), IEEE 802.11, IP, IPV6, TCP/IP, UDP, DTN, HTTP, FTP, SNMP, SMS, MMS, SS7, JSON, SOAP, CORBA, REST and Web Services. To ensure data transfer is secure, the computer systems may transmit data via the network using a variety of security measures including, for example, TSL, SSL or VPN.

The computer systems include processors that may perform a series of instructions that result in manipulated data. The processor may be a commercially available processor such as an Intel Xeon, Itanium, Core, Celeron, Pentium, AMD Opteron, Sun UltraSPARC, IBM Power5+, or IBM mainframe chip, but may be any type of processor, multiprocessor or controller.

A memory may be used for storing programs and data during operation of the device. Thus, the memory may be a relatively high performance, volatile, random access memory such as a dynamic random access memory (DRAM) or static memory (SRAM). However, the memory may include any device for storing data, such as a disk drive or other non-volatile storage device. Various examples may organize the memory into particularized and, in some cases, unique structures to perform the functions disclosed herein.

As discussed, the devices 100, 150, or 200 may also include one or more interface devices such as input devices and output devices. Interface devices may receive input or provide output. More particularly, output devices may render information for external presentation. Input devices may accept information from external sources. Examples of interface devices include keyboards, mouse devices, trackballs, microphones, touch screens, printing devices, display screens, speakers, network interface cards, etc. Interface devices allow the computer system to exchange information and communicate with external entities, such as users and other systems.

Data storage may include a computer readable and writeable nonvolatile (non-transitory) data storage medium in which instructions are stored that define a program that may be executed by the processor. The data storage also may include information that is recorded, on or in, the medium, and this information may be processed by the processor during execution of the program. More specifically, the information may be stored in one or more data structures specifically configured to conserve storage space or increase data exchange performance. The instructions may be persistently stored as encoded signals, and the instructions may cause the processor to perform any of the functions described herein. The medium may, for example, be optical disk, magnetic disk or flash memory, among others. In operation, the processor or some other controller may cause data to be read from the nonvolatile recording medium into another memory, such as the memory, that allows for faster access to the information by the processor than does the storage medium included in the data storage. The memory may be located in the data storage or in the memory, however, the processor may manipulate the data within the memory, and then copy the data to the storage medium associated with the data storage after processing is completed. A variety of components may manage data movement between the storage medium and other memory elements and examples are not limited to particular data management components. Further, examples are not limited to a particular memory system or data storage system.

Various aspects and functions may be practiced on one or more computers having a different architectures or components than that shown in the figures. For instance, one or more components may include specially programmed, special-purpose hardware, such as for example, an application-specific integrated circuit (ASIC) tailored to perform a particular operation disclosed herein. While another example may perform the same function using a grid of several general-purpose computing devices running MAC OS System X with Motorola PowerPC processors and several specialized computing devices running proprietary hardware and operating systems.

One or more components may include an operating system that manages at least a portion of the hardware elements described herein. A processor or controller may execute an operating system which may be, for example, a Windows-based operating system, such as, Windows NT, Windows 2000 (Windows ME), Windows XP, Windows Vista or Windows 7 operating systems, available from the Microsoft Corporation, a MAC OS System X operating system available from Apple Computer, an Android operating system available from Google, one of many Linux-based operating system distributions, for example, the Enterprise Linux operating system available from Red Hat Inc., a Solaris operating system available from Sun Microsystems, or a UNIX operating systems available from various sources. Many other operating systems may be used, and examples are not limited to any particular implementation.

The processor and operating system together define a computer platform for which application programs in high-level programming languages may be written. These component applications may be executable, intermediate, bytecode or interpreted code which communicates over a communication network, for example, the Internet, using a communication protocol, for example, TCP/IP. Similarly, aspects may be implemented using an object-oriented programming language, such as .Net, SmallTalk, Java, C++, Ada, or C# (C-Sharp). Other object-oriented programming languages may also be used. Alternatively, functional, scripting, or logical programming languages may be used.

Additionally, various aspects and functions may be implemented in a non-programmed environment, for example, documents created in HTML, XML or other format that, when viewed in a window of a browser program, render aspects of a graphical-user interface or perform other functions. Further, various examples may be implemented as programmed or non-programmed elements, or any combination thereof. For example, a web page may be implemented using HTML while a data object called from within the web page may be written in C++. Thus, the examples are not limited to a specific programming language and any suitable programming language could be used. Thus, functional components disclosed herein may include a wide variety of elements, e.g. executable code, data structures or objects, configured to perform described functions.

What is claimed is:

1. A device comprising:
an input/output element;
a device controller configured to detect a user input event;
an embedded web browser; and
a state controller executing as an interpreted language application on the embedded web browser, the state controller configured to:
receive an indication of the user input event;
determine an updated state of the input/output element responsive to the user input event;
change a state of the input/output element to the updated state; and
cause the input/output element to be updated according to the updated state.

2. The device of claim 1, wherein the interpreted language application is implemented in HTML5 and javascript.

3. The device of claim 1, wherein the interpreted language application is configured to operate with reference to a first non-compiled file, and wherein the state controller is further configured to receive a second non-compiled file and operate the interpreted language application with reference to the second non-compiled file.

4. The device of claim 3, wherein the first non-compiled file is hot swapped with the second non-compiled file during operation of the device.

5. The device of claim 3, wherein at least one of the first non-compiled file and the second-non-compiled file associates the user input event with an intended action and the updated state.

6. The device of claim 1, wherein the user input event is detected at a user interface at least partially overlapping with the input/output element.

7. The device of claim 1, further comprising providing the updated state of the input/output element to the device controller.

8. The device of claim 1, wherein the state controller is configured to change the state of the input/output element to the updated state by writing a web frame to be rendered on the input/output element.

9. The device of claim 1, wherein the state controller is further configured to request, from the device controller, content for the updated state.

10. The device of claim 9, wherein the input/output element is a lightbar, and the content is at least one lightbar pattern.

11. The device of claim 1, wherein the state controller is communicatively coupled to the device controller by at least one websocket.

12. The device of claim 1, wherein the input/output element comprises at least one of a button, a key, a touch region, a capacitive region, a lightbar, and a display.

13. A method of operating a device having a input/output element, the method comprising:
detecting a user input event;
receiving, by a state controller executing as an interpreted language application on an embedded web browser of the device, an indication of the user input event;
determining, by the state controller, an updated state of the input/output element responsive to the user input event;
changing, by the state controller, a state of the input/output element to the updated state; and
causing the input/output element to be updated according to the updated state.

14. The method of claim 13, wherein the interpreted language application is configured to operate with reference to a first non-compiled file, further comprising:
receiving a second non-compiled file; and
operating the interpreted language application with reference to the second non-compiled file.

15. The method of claim 14, further comprising hot swapping the first non-compiled file with the second non-compiled file during operation of the device.

16. The method of claim 14, wherein at least one of the first non-compiled file and the second-non-compiled file associates the user input event with an intended action and the updated state.

17. The method of claim 13, further comprising providing, by the state controller, the updated state of the input/output element to the device controller.

18. The method of claim 13, wherein changing the state of the input/output element to the updated state comprises writing a web frame to be rendered on the input/output element.

19. The method of claim 13, further comprising requesting, by the state controller, content for the updated state from the device controller.

20. The method of claim 19, wherein the input/output element is a lightbar, and the content is at least one lightbar pattern.

21. The method of claim 13, wherein the user input event is detected at a user interface comprising a capacitive region, and wherein receiving the indication of the user input event comprises receiving coordinates of a location on the capacitive region contacted by a user, and wherein determining the updated state of the input/output element responsive to the user input comprises determining, from the coordinate of the location on the capacitive region contacted by the user, a predefined input value.

22. The method of claim 13, wherein the user input event is one of a key hover, a key press, a key press and release, a key press and hold, and a repeated key press and hold.

23. The method of claim 13, wherein the input/output element comprises at least one of a button, a key, a touch region, a capacitive region, a lightbar, and a display.
